(19) United States
(12) Patent Application Publication
(10) Pub. No.: US 2022/0397757 A1
(43) Pub. Date: Dec. 15, 2022

(54) DEVICE FOR REALIZING SURFACE CLEANING OF OPTICAL ELEMENT BY ION WIND AND ELECTROSTATIC COUPLING

(71) Applicant: Harbin Institute of Technology, Harbin City, Heilongjiang (CN)

(72) Inventors: Qingshun Bai, Harbin (CN); Yuhao Dou, Harbin (CN); Yichen Zhang, Harbin (CN); Chenghao Xie, Harbin (CN); Longfei Niu, Harbin (CN); Xinxiang Miao, Harbin (CN)

(73) Assignee: Harbin Institute of Technology, Harbin City, Heilongjiang (CN)

(21) Appl. No.: 17/776,172

(22) PCT Filed: Jan. 4, 2021
(86) PCT No.: PCT/CN2021/070123

§ 371 Date: May 11, 2022

(30) Foreign Application Priority Data
Jan. 20, 2020 (CN) 202010066540.5

(51) Int. Cl. G02B 27/00; B08B 5/02; B08B 13/00; B03C 3/017; B03C 3/06; B03C 3/49; B03C 3/86; G02B 7/182

(52) U.S. Cl. CPC G02B 27/0006; B08B 5/02; B08B 13/00; B03C 3/017; B03C 3/06; B03C 3/49; B03C 3/86; G02B 7/182

(57) ABSTRACT

A device for realizing surface cleaning of an optical element by ion wind and electrostatic coupling, comprising a fixing support, an optical element, an ion wind system, an electrostatic adsorption system, and a particle contaminant storage box; the ion wind system comprises an air knife, an ion bar, an ion bar support, a connecting sheet, and a three-degree-of-freedom combined displacement stage; the electrostatic adsorption system comprises rod-shaped electrodes, electrode fixing supports and a manual displacement stage; the particle contaminant storage box is connected to a working surface by means of storage box supports, and an included angle between the particle contaminant storage box and the storage box supports is 135 degrees.

### TECHNICAL FIELD

The present disclosure belongs to the technical field of surface cleaning of large-aperture optical elements, and relates to a device for realizing surface cleaning of an optical element by ion wind and electrostatic coupling.

### BACKGROUND ART

The high-energy laser system has a large number of large-caliber optical elements including lenses, windows, reflectors and transmitting mirrors. The cleaning characteristic of the optical element plays an important role in stable operation of the system, and the failure form of the optical element is mainly laser damage.

In high-energy laser facilities, various contaminants adhered to the surface of the optical element are also closely related to surface damage, the particle contaminants are plasmatized under the action of the high-energy laser, and the high-temperature and high-speed plasma causes burn damage to the optical element, so that maintaining of the cleanliness of the optical surface is crucial for prolonging the service life of the element and maintaining the performance of the element.

Under the irradiation of the high-energy laser, fine dust in the space where the laser is located is easily ionized so as to carry charges and then is adsorbed on the surface of the optical element to form defects of the optical element. If the defects are not cleaned in time, under the subsequent irradiation of the high-energy laser, the defects on the surface of the optical element can cause self-destruction due to over high energy magnitude of the laser; and then, on the basis of the original defects, the surface structure of the optical element is further damaged, an ablation phenomenon is generated, and even new particle contaminants are generated, so that irreversible surface damage is caused. Therefore, in order to prevent the damage of fine dust in the space to the optical element, the particle contaminants need to be regularly removed in the using process to reach a certain cleanliness standard, so that the service life of the device can be prolonged under the condition of ensuring that the experiment is carried out orderly.

### SUMMARY

The present disclosure aims to solve the problem that particles are contaminated by space existing above an optical element, and provides a device for realizing surface cleaning of an optical element by ion wind and electrostatic coupling. From the angle of plasma wind and electrostatic coupling, the surface cleaning of the optical element is taken as a research object, a device feasibility experiment based on electrostatic adsorption and air knife blowing is carried out, a corresponding electrostatic adsorption device of particle contaminants is developed, adsorption and collection of suspended particles in a reflector are achieved, and the purpose of efficient removal of the particle contaminants is achieved. The blowing working state of ion wind can be monitored in real time, the device can also feedback the implementation voltage of the electrostatic adsorption device in real time, and data are provided for the operators to make a long-term cleaning plan.

To achieve the purpose, the present disclosure adopts the following technical scheme:

Disclosed is a device for realizing surface cleaning of an optical element by ion wind and electrostatic coupling. The device comprises a fixing support, an optical element, an ion wind system, an electrostatic adsorption system, and a particle contaminant storage box;

The fixing support is a triangular prism which is horizontally placed, the inclined surface of the front side of the fixing support is a working surface, an included angle between the working surface and the horizontal plane is 45 degrees, a bottom plate is fixed on the working surface, and the ion wind system, the electrostatic adsorption system and the particle contaminant storage box are fixed on the bottom plate from top to bottom;

The ion wind system comprises an air knife, an ion bar support, a three-degree-of-freedom combined displacement stage, an ion bar and a connecting sheet, the three-degree-of-freedom combined displacement stage is connected with the air knife through the connecting sheet, the air knife, at the position close to two ends, is connected with two ion bar supports, and the ion bar is fixed on the two ion bar supports;

The electrostatic adsorption system comprises two electrode fixing supports I, two electrode fixing supports II, two electrode fixing supports III, a rod-shaped electrode positive electrode, a rod-shaped electrode negative electrode and a manual displacement stage, the two electrode fixing supports I and the two electrode fixing supports II are all transversely arranged along the bottom plate and fixed on the bottom plate, the two electrode fixing supports II are arranged on the inner sides of the two electrode fixing supports I, and the rod-shaped electrode negative electrode adjusts the height of the rod-shaped electrode negative electrode through jackscrews fixed at different positions on the two electrode fixing supports II; and the two electrode fixing supports I and the two electrode fixing supports II are connected through a manual displacement stage, and the rod-shaped electrode positive electrode is installed on the two electrode fixing supports III.

Compared with the prior art, the device has the beneficial effects that the ion wind and electrostatic coupling mode is adopted, the device has the characteristics of being compact in structure, high in controllability, capable of achieving multi-set linkage, high in safety, large in blowing force, wide in blowing range, high in blowing efficiency and so on. Most of connection is threaded connection, and therefore the device is convenient in installation, simple and effective in structure and low in cost, the blowing efficiency of different particle contaminants can reach more than 80%, the surface cleanliness of the optical element in actual use is guaranteed, the only remote control is needed in actual use, the power supply is provided with a leakage protection system, and the safety of personnel and the device in the whole process is guaranteed. For an electrode for adsorption, particles are adsorbed and stored in a receiving tank of the electrode, so that collection and cleaning are facilitated.

### BRIEF DESCRIPTION OF THE DRAWINGS

FIG. 1 is an integral structural schematic diagram of the present disclosure;

FIG. 2 is a schematic diagram of an ion wind system in the present disclosure;

FIG. 3 is a schematic diagram of an electrostatic adsorption system in the present disclosure; and

FIG. 4 is a schematic diagram of a particle contaminant storage box in the present disclosure.

Illustrative features are assigned the following reference numerals: 1, fixing support; 1-1, working surface; 2, optical element; 3, ion wind system; 4, electrostatic adsorption system; 5, particle contaminant storage box; 6, wind knife; 7, ion bar support; 8, three-degree-of-freedom combined displacement stage; 9, ion bar; 10, connecting sheet; 11-1, electrode fixing support I; 11-2, electrode fixing support II; 11-3, electrode fixing support III; 12, rod-shaped electrode positive electrode; 13, rod-shaped electrode negative electrode; 14, manual displacement stage; and 15, storage box support.

### DETAILED DESCRIPTION

The technical scheme of the present disclosure is further described below in conjunction with the attached figures, but is not limited thereto, and correction or equivalent substitution of the technical scheme of the present disclosure without departing from the spirit scope of the technical scheme of the present disclosure should be included in the protection scope of the present disclosure.

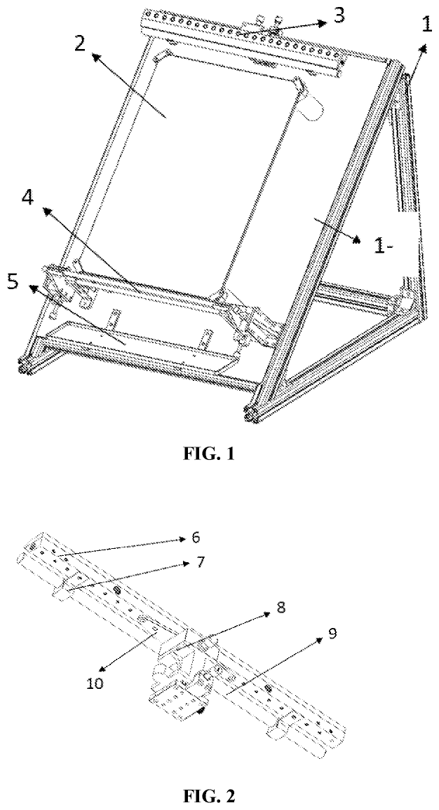

In the first specific embodiment, a device for realizing surface cleaning of an optical element by ion wind and electrostatic coupling is recorded in the embodiment. As shown in FIG. 1, the device comprises a fixing support 1, an optical element 2 (a reflector or other optical elements with smooth surface), an ion wind system 3, an electrostatic adsorption system 4, and a particle contaminant storage box 5;

the fixing support 1 is a triangular prism which is horizontally placed, the inclined surface of the front side of the fixing support 1 is a working surface 1-1, an included angle between the working surface 1-1 and the horizontal plane is 45 degrees, a bottom plate is fixed on the working surface 1-1 (through bolts), and the ion wind system 3, the electrostatic adsorption system 4 and the particle contaminant storage box 5 are fixed on the bottom plate (through bolts) from top to bottom;

as shown in FIG. 2, the ion wind system 3 comprises an air knife 6, an ion bar support 7, a three-degree-of-freedom combined displacement stage 8, an ion bar 9 and a connecting sheet 10, the three-degree-of-freedom combined displacement stage 8 is connected with the air knife 6 through the connecting sheet 10 (with bolts), the air knife 6, at the position close to two ends, is connected with two ion bar supports 7 (through bolts respectively), and the ion bar 9 is fixed on the two ion bar supports 7; and the three-degree-of-freedom combined displacement stage is composed of three parts, and in order to achieve the adjusting function, a Zolix manual displacement stage is selected and comprises the following models: an SKW25-65C type manual displacement stage, a KSMV13A-65Z type manual lifting stage and a KSMG-15-65 manual angular displacement stage. Single-degree-of-freedom displacement is achieved through the manual displacement stage, single-degree-of-freedom lifting is achieved through the manual lifting stage, single-degree-of-freedom pitch angle adjustment can be achieved through the manual angular displacement stage, and the three stages are combined to form the three-degree-of-freedom combined displacement stage. The blowing-out speed of the air knife is determined by an air pump and can reach more than 8 atm. The three-degree-of-freedom combined displacement stage is fixed on a base to be fixed through four bolts at the bottom, and the appropriate positions of the air knife 6 and the ion bar 9 can be adjusted through the three-degree-of-freedom combined displacement stage.

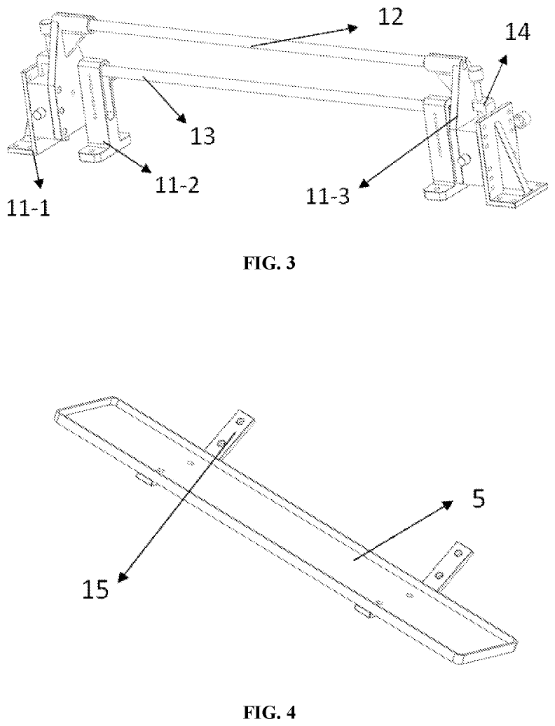

As shown in FIG. 3, the electrostatic adsorption system 4 comprises two electrode fixing supports I 11-1, two electrode fixing supports II 11-2, two electrode fixing supports III 11-3, a rod-shaped electrode positive electrode 12, a rod-shaped electrode negative electrode 13 and a manual displacement stage 14, the two electrode fixing supports I 11-1 and the two electrode fixing supports II 11-2 are all transversely arranged along the bottom plate and fixed on the bottom plate (through bolts), the two electrode fixing supports II 11-2 are arranged on the inner sides of the two electrode fixing supports I 11-1, and the rod-shaped electrode negative electrode 13 adjusts the height of the rod-shaped electrode negative electrode 13 through jackscrews fixed at different positions on the two electrode fixing supports II 11-2; and the two electrode fixing supports I 11-1 and the two electrode fixing supports II 11-2 are connected through a manual displacement stage 14, and the rod-shaped electrode positive electrode 12 is installed on the two electrode fixing supports III 11-3.

The manual displacement stage 14 is a Zolix SKW25-65CC/SKW25-65CC-L type manual displacement stage, the vertical displacement distance of the manual displacement stage 14 can be controlled, and the height of the rod-shaped electrode negative electrode 13 can be adjusted through jackscrews fixed at different positions on the electrode fixing supports II 11-2. The two electrode fixing supports I 11-1, the two electrode fixing supports II 11-2 and the two electrode fixing supports III 11-3 are distributed at corresponding symmetrical positions; and the electrode fixing support I 11-1 is used for connecting the manual displacement stage and the bottom plate, the electrode fixing support II 11-2 is used for connecting the bottom plate and the electrode negative electrode, and the electrode fixing support II 11-3 is used for connecting the manual displacement stage and the electrode positive electrode.

When in use, the electrode fixing support I 11-1 can be firstly fixed at a required position, then the manual displacement stage 14 is fixed on the electrode fixing support I 11-1 through four M6 through holes in the manual displacement stage 14, and then the rod-shaped electrode positive electrode 12 and the rod-shaped electrode negative electrode 13 inserted with electric wires are respectively fixed on the electrode fixing support III 11-3 and the electrode fixing support II 11-2. Then, the rod-shaped electrode positive electrode 12 and the wire are fixed on a left manual displacement stage 14 and a right manual displacement stage 14 together with the electrode fixing support III 11-3 by using M6 bolts through reserved through holes, and the rod-shaped electrode negative electrode 13 and the electrode fixing support II 11-2 are fixed by using M1.5 bolts.

In the second embodiment, according to the device for realizing surface cleaning of an optical element by ion wind and electrostatic coupling in the first embodiment, the width of the air knife 6 and the width of the ion bar 9 are 610 mm, the diameter φ of the ion bar 9 is 12 mm, and the length and the height of the ion air system 3 are 132 mm and 145 mm respectively. The length is in the direction perpendicular to the width along the working surface, and the height is in the direction perpendicular to the working surface 1-1.

In the third embodiment, according to the device for realizing surface cleaning of an optical element by ion wind and electrostatic coupling in the first embodiment, the ion bar support 7 is connected with the air knife 6 through bolts, and the ion bar support 7 is of elasticity. After the ion bar 9 is clamped into the ion bar support 7, the elastic force can be generated due to deformation, and then it is guaranteed that the ion bar 9 cannot slip. The air knife 6 is fixed on the three-degree-of-freedom combined displacement stage 8 through four bolt holes formed in the connecting sheet 10. Three M6 countersunk bolts are additionally arranged on the connecting sheet 10 so as to ensure the fixation of the connecting sheet 10 and the three-degree-of-freedom combined displacement stage 8.

In the fourth embodiment, according to the device for realizing surface cleaning of an optical element by ion wind and electrostatic coupling in the first embodiment, the distance between the electrode fixing supports I 11-1 is 700 mm, and the voltage between the rod-shaped electrode positive electrode 12 and the rod-shaped electrode negative electrode 13 is 0-15 KV. The output voltage can also be changed through a method of modifying a battery.

According to a using method of the device, the ion bar 9 is electrified to ionize air and generate ions, an air knife electromagnetic valve located on an air knife power source receives a control signal to open and close the air knife 6, the blowing time of the air knife 6 is determined, the ion wind with the ions is generated through the blowing effect of the air knife 6, and after the ion wind impacts charged particles on the optical element 2, the particles are not charged, the contact force with the optical element 2 is weakened, and the particles are blown and flow with the wind towards the electrostatic adsorption system 4. When the particles enter the electrostatic adsorption range, the particles are adsorbed to the electrode under the action of adsorbing the small particles by the high-voltage electrodes and under the action of gravity, and if the particles are charged, the particles are adsorbed to the electrode with the opposite electric property under the action of an electric field, so that the effect of electrostatic adsorption is achieved. In the ion wind system 3, it can be guaranteed that ion wind is generated in the actual using process. The air pressure of the air knife 6 is determined by the air pump, high-speed air flow can be generated to drive ionized ions, the voltage of generated ionic wind is 0-15 KV in the electrostatic adsorption system, and it is guaranteed that the charged particles are adsorbed to a designated electrode.

As shown in FIG. 1, in order to collect the particle contaminants on the rod-shaped electrode positive electrode 12 and the rod-shaped electrode negative electrode 13 and prevent the contaminants from polluting the reflector again, the particle contaminant storage box 5 is designed at the lower parts of the rod-shaped electrode positive electrode 12 and the rod-shaped electrode negative electrode 13. After power failures of high voltage static electrodes, the adsorbed particle contaminants fall into the particle contaminant storage box 5 under the action of gravity. The manual displacement stage 14 is fixed to the reserved installation position on the bottom plate through the electrode fixing support I 11-1, and the particle contaminant storage box 5 is fixed to the reserved installation position on the bottom plate through the storage box support 15. FIG. 1 is a complete assembly diagram of the device. The device comprises an air knife 6 at the upper part, an ion bar 9, and a rod-shaped electrode positive electrode 12 and a rod-shaped electrode negative electrode 13 at the lower part, and in addition to the air knife 6, the ion bar 7, the rod-shaped electrode positive electrode 12, the rod-shaped electrode negative electrode 13 and related supporting structures (an ion bar support 7, storage box supports), a connecting piece necessary for installing the assembly on the reflector is further arranged in the diagram.

In the fifth embodiment, according to the device for realizing surface cleaning of an optical element by ion wind and electrostatic coupling in the first embodiment, slot holes are correspondingly formed in the two opposite side faces of the two electrode fixing supports II 11-2, a plurality of jackscrew holes communicating with the slot holes are formed in the outer side faces of the two electrode fixing supports II 11-2 respectively, the jackscrew holes are formed in the height direction of the electrode fixing supports II 11-2, the two ends of the rod-shaped electrode negative electrode 13 are inserted into the two corresponding slot holes, and the rod-shaped electrode negative electrode 13 is fixedly connected with the two electrode fixing supports II 11-2 through the jackscrews in threaded connection with the jackscrew holes.

In the sixth embodiment, according to the device for realizing surface cleaning of an optical element by ion wind and electrostatic coupling in the first embodiment, as shown in FIG. 4, the particle contaminant storage box 5 is connected with the working surface 1-1 through storage box supports 15.

In the seventh embodiment, according to the device for realizing surface cleaning of an optical element by ion wind and electrostatic coupling in the sixth embodiment, as shown in FIG. 4, an included angle between the particle contaminant storage box 5 and the storage box supports 15 is 135 degrees.

In the eighth embodiment, according to the device for realizing surface cleaning of an optical element by ion wind and electrostatic coupling in the first embodiment, wherein the optical element 2 is detachably connected with the bottom plate through four supporting columns at the four corners.

1. A device for realizing surface cleaning of an optical element by ion wind and electrostatic coupling, comprising a fixing support, an optical element, an ion wind system, an electrostatic adsorption system, and a particle contaminant storage box,
wherein
the fixing support is a triangular prism which is horizontally placed, the inclined surface of the front side of the fixing support is a working surface, an included angle between the working surface and the horizontal plane is 45 degrees, a bottom plate is fixed on the working surface, wherein the ion wind system, the electrostatic adsorption system and the particle contaminant storage box are fixed on the bottom plate from top to bottom;
the ion wind system comprises an air knife, an ion bar support, a three-degree-of-freedom combined displacement stage, an ion bar and a connecting sheet, wherein the three-degree-of-freedom combined displacement stage is connected with the air knife through the connecting sheet, the air knife, at the position close to two ends, is connected with two ion bar supports, and the ion bar is fixed on the two ion bar supports; and
the electrostatic adsorption system comprises two electrode fixing supports I, two electrode fixing supports II, two electrode fixing supports III, a rod-shaped electrode positive electrode, a rod-shaped electrode negative electrode and a manual displacement stage, the two electrode fixing supports I and the two electrode fixing supports II are all transversely arranged along the bottom plate and fixed on the bottom plate, the two electrode fixing supports II are arranged on the inner sides of the two electrode fixing supports I, and the rod-shaped electrode negative electrode adjusts the height of the rod-shaped electrode negative electrode through jackscrews fixed at different positions on the two electrode fixing supports II, and the two electrode fixing supports I and the two electrode fixing supports II are connected through a manual displacement stage, and the rod-shaped electrode positive electrode is installed on the two electrode fixing supports III.

2. The device for realizing surface cleaning of an optical element by ion wind and electrostatic coupling according to claim 1, wherein the width of the air knife and the width of the ion bar are 610 mm, the diameter φ of the ion bar is 12 mm, and the length and the height of the ion air system are 132 mm and 145 mm respectively.

3. The device for realizing surface cleaning of an optical element by ion wind and electrostatic coupling according to claim 1, wherein the ion bar support is connected with the air knife through bolts, and the air knife is fixed on the three-degree-of-freedom combined displacement stage through four bolt holes formed in the connecting sheet.

4. The device for realizing surface cleaning of an optical element by ion wind and electrostatic coupling according to claim 1, wherein the distance between the electrode fixing supports I is 700 mm, and the voltage between the rod-shaped electrode positive electrode and the rod-shaped electrode negative electrode is 0-15 KV.

5. The device for realizing surface cleaning of an optical element by ion wind and electrostatic coupling according to claim 1, wherein slot holes are correspondingly formed in the two opposite side faces of the two electrode fixing supports II, a plurality of jackscrew holes communicating with the slot holes are formed in the outer side faces of the two electrode fixing supports II respectively, the jackscrew holes are formed in the height direction of the electrode fixing supports II, the two ends of the rod-shaped electrode negative electrode are inserted into the two corresponding slot holes, and the rod-shaped electrode negative electrode is fixedly connected with the two electrode fixing supports II through the jackscrews in threaded connection with the jackscrew holes.

6. The device for realizing surface cleaning of an optical element by ion wind and electrostatic coupling according to claim 1, wherein the particle contaminant storage box is connected with the working surface through storage box supports.

7. The device for realizing surface cleaning of an optical element by ion wind and electrostatic coupling according to claim 6, wherein an included angle between the particle contaminant storage box and the storage box supports is 135 degrees.

8. The device for realizing surface cleaning of an optical element by ion wind and electrostatic coupling according to claim 1, wherein the optical element is detachably connected with the bottom plate through four supporting columns at the four corners.
